(19) United States
(12) Patent Application Publication
(10) Pub. No.: US 2024/0025287 A1
(43) Pub. Date: Jan. 25, 2024

(54) CHARGER FOR A SERVICE BATTERY OF AN ELECTRIC VEHICLE AND ELECTRIC VEHICLE COMPRISING SUCH A CHARGER

(71) Applicant: ATEQ, Les Clayes-sous-Bois (FR)

(72) Inventor: Jacques Mouchet, Les Clayes-sous-Bois (FR)

(21) Appl. No.: 18/266,257

(22) PCT Filed: Dec. 9, 2021
(86) PCT No.: PCT/EP2021/084963

§ 371 Date: Jun. 8, 2023

(30) Foreign Application Priority Data
Dec. 10, 2020 (FR) FR2013012

(51) Int. Cl. B60L 53/57; H02J 7/00; H02J 7/34

(52) U.S. Cl. CPC B60L 53/57; H02J 7/00304; H02J 7/342; H02J 2310/48

(57) ABSTRACT

The present invention relates to a charger (1; 10) for a service battery of an electric vehicle, the charger including: an electrical power source (3); an electrical connection (5) configured to be connected to the electrical service network of the vehicle and connect the electrical power source (3) to the battery of the vehicle; an electrical management circuit (7; 27) configured to limit the intensity of the electrical current (I_{OUT}) flowing, via the electrical service network, from the electrical power source (3) to the vehicle battery.

The present invention relates to the field of devices for electrically charging a battery, and more particularly a service battery mounted in an electric and/or hydrogen electric vehicle (also referred to as PEV and H2EV respectively).

A service battery is understood to mean a battery that supplies power, in particular electricity, to the functional and/or safety components of the vehicle, such as the electronic control unit, the door locking system, the OBD (on-board diagnostics) link, the autonomous driving aids, the LED headlights, the parking brake, the radio, the global positioning system, and the traction power management system, etc. The electrical network powered by said service battery is thus typically referred to as the “electrical service network”.

Service batteries for electric vehicles are typically lower capacity batteries than traction batteries, and have a rated voltage of 12 volts. These are so-called “deep cycle” batteries, also called “slow-discharge” batteries, because they do not cope well with high current draw (they are not designed to start an internal combustion engine), but cope very well with deep discharges, up to 80% of their capacity. These batteries are typically disposed in the electric traction compartment (surrounded by safety guards) and are hardly or not at all accessible. Moreover, in order to protect these batteries from destructive interventions, the use of cables to connect them to another vehicle is prohibited in most electric vehicle user manuals.

It should also be noted that the term “service battery” can be used interchangeably with the term “function battery”, which terms can be used indifferently to designate this type of battery, and which differentiates them from so-called starter batteries.

The service battery is connected to the storage battery or traction battery of the vehicle, for example via a DC/DC converter, to enable said service battery to remain charged and operational and to ensure the correct functioning of the various functional and/or safety components of the vehicle. Electric or hydrogen electric vehicles do not have alternators for recharging batteries.

Thus, when the service battery is discharged due to a problem with the converter, a short-circuit, external stresses, intensive use of the storage and function batteries (causing them to be completely discharged), or an extended period of non-use of the vehicle, the service battery must be able to be recharged in order to allow some of the basic functions of the vehicle to be used and accessed.

More particularly, if the service battery has a voltage value that is below a predetermined value, for example below 12 V, the various functional and safety components can no longer be activated. The user can thus no longer use the central door release control (only the mechanical back-up key can be used to unlock the driver's door), nor start the vehicle, nor even move it (the electric parking brake is blocked), to take it to the nearest garage for repair. Moreover, in many cases the vehicle cannot be lifted in order to be moved.

Furthermore, service batteries, typically of the “gel electrolyte” type, typically have electrical constraints. This type of battery does not withstand current spikes, particularly when deeply discharged, unlike conventional lead-acid batteries used in combustion engine cars. A high-current lead-acid battery charger cannot thus be used without risking damage to the service battery of an electric vehicle.

Moreover, the service battery of an electric vehicle is very difficult to access for the average user, for reasons concerning user safety and the warranty of said vehicle.

Thus, the present invention proposes overcoming at least one of the aforementioned drawbacks and provides a new type of battery charger for an electric vehicle.

The present invention thus relates to a charger for a service battery, in particular for an electric vehicle, said charger comprising:
an electrical power source;
an electrical connection configured to be connected to the electrical service network of the vehicle and connect said electrical power source to the battery of the vehicle;
an electrical management circuit configured to limit the intensity of the electrical current flowing, via the electrical service network, from the electrical power source to the battery of the vehicle.

Said battery charger according to the invention avoids, in particular, having to access said battery in the engine compartment, where the battery is difficult to access, which sometimes requires dismantling other elements in order to gain access to said service battery.

Moreover, the charger allows said battery to be charged in a simple manner, and thus allows an electric vehicle with a discharged service battery to be quickly and easily repaired.
Furthermore, said charger comprises an electrical management circuit that limits the charging current intensity to a predetermined maximum value, for example to 10 amps, and preferably to 8 amps. This limitation of the charging current intensity thus ensures that the battery (when charging) or any element of the electrical network of said vehicle is not damaged.

According to one possible feature, said electrical connection is configured to connect to a cigarette lighter socket and/or a fuse plug.

It should be noted that a large proportion of vehicles have a so-called cigarette lighter socket, supplied with a current of intensity between 10 and 20 A, which allows cigars or cigarettes to be lit. However, nowadays, these sockets are mainly used to power accessories, such as chargers, vacuum cleaners, tyre pumps or converters to generate 220 V AC, etc.

The power supply circuit of some vehicles thus includes a protection fuse that can take two positions depending on the driver's preference:
a first so-called “continuous power” position, in which said cigarette lighter socket is electrically connected to the battery (and thus powered), even when the vehicle is switched off;
a second so-called “cut-off” position, preventing any electrical connection between said socket and the service battery (and thus not allowing the service battery to be recharged) when the vehicle is switched off (or when the ignition is switched off).
   Thus, in order to recharge the service battery without damaging the fuse positioned in a first position, it is important that the recharging current intensity of the service battery is limited.
   Moreover, all vehicles comprise a fuse box, typically disposed in the passenger compartment of the vehicle.
   Thus, being able to connect to the cigarette lighter socket when it is operational when the ignition is switched off, or to a fuse plug of a fuse box, simplifies and speeds up the operation for recharging the battery of the vehicle.

In other respects, a higher current configuration is possible for vehicles with a fuse having a larger fuse rating and a battery capable of accepting a higher deep discharge output current (such as the batteries fitted in lorries or buses, etc.).

According to one possible feature, said electrical power source is a battery with a rated voltage that is higher than the rated operating voltage of the battery to be charged.

According to another possible feature, said electrical power source comprises one or more of the following elements: cell, battery, capacitor, supercapacitor or any other voltage source or generator.

According to another possible feature, said electrical power source comprises the traction (or storage) battery of said vehicle, said charger being configured to be electrically connected to said traction battery.

According to another possible feature, said battery of said charger is an electric battery of the lithium-ion type and preferably a multi-cell electric battery having a rated voltage of at least 14 V, and preferably a rated voltage of at least 16 V.

The battery of said charger comprises, for example, 4 lithium-ion cells, disposed in series, each having voltages ranging from 3.5 to 4.2 V and the dimensions of the pack of 4 cells being, for example, 84×70×21 mm.
This embodiment of said electrical power source has the advantages of being particularly cost-effective and compact, while giving the tool an advantageous autonomy.

According to another possible feature, said electrical management circuit limits the intensity of the current flowing in said electrical connection (or charging current), said charging current flowing in particular through the electrical service network, to a predetermined value. To this end, it can comprise a current-limiting circuit.

According to another possible feature, said electrical management circuit limits the charging current intensity to a predetermined value, such as to 10 amps, and preferably to 8 amps.

This current value limits the risk of damage to the service battery to be charged, but also to all of the elements of the electrical service network of said vehicle.

According to another possible feature, said electrical management circuit is configured to raise and/or lower the voltage of the electrical power source (in particular of a battery).

Said electrical management circuit is advantageously configured to raise and/or lower the voltage of the electrical power source such that the output voltage of said electrical management circuit is always adapted with respect to the rated voltage value of the battery to be charged, and thus to ensure an optimal charge of said service battery of the vehicle.

According to another possible feature, said charger comprises a human-machine interface configured to indicate one or more of the following pieces of information to the user of said charger:
said charger is switched on;
said charger is currently charging the service battery of the vehicle;
the voltage value of the battery to be charged has reached or exceeds a predetermined voltage value;
the voltage value of the battery to be charged and/or of the electrical power source;
the electrical power source of said charger is charged up and/or exceeds a predetermined voltage value;
the charge and/or the voltage value of the electrical power source of said charger.

It should also be noted that said charger can thus be configured to perform diagnostics on the service battery by measuring the voltage thereof, such as an open-circuit voltage measurement. Said measurement can be carried out prior to charging and/or during charging after it has been momentarily interrupted (or suspended).

According to another possible feature, said charger automatically switches off as soon as the voltage of the battery to be charged exceeds a threshold value. This function prevents the user from overcharging the battery of the electric vehicle and limits misuse of the charger by the user.

According to another possible feature, said charger comprises a USB socket configured to supply electrical power to said electrical power source. The battery of said charger can thus be easily recharged via the USB socket.

Said invention further relates to a charger which is, on the one hand, configured to perform diagnostics on said service battery and which is, on the other hand, integrated into the vehicle, said power source of the charger being the traction battery of said vehicle.

Thus, in the event of excessive discharge of the service battery when the vehicle is stopped, the charger can be switched on, automatically or manually, to maintain a predetermined charge of said service battery (at an acceptable current) to avoid resulting in a discharge that no longer allows said vehicle to be started.

It should also be noted that said charger can also be referred to as a “recharging and diagnostics device” for a service battery of a motor vehicle.

The present invention further relates to an electric or hydrogen electric car, characterised in that said car comprises a charger for a service battery as defined hereinabove, said charger being an on-board system of said vehicle.

Said charger according to the invention can thus be integrated into an electric or hydrogen electric vehicle as a back-up system in the event of failure of the service battery.

The present invention further relates to a method for repairing a service battery of an electric or hydrogen electric vehicle:
connecting an electrical power source to the electrical service network of the vehicle;
supplying the service battery of the vehicle via the electrical network with a current, the intensity whereof is limited to a predetermined value.

According to one possible feature, the method comprises a step of warning the user when the voltage value of the battery has reached a predetermined voltage value.

According to another possible feature, the step of connecting to the electrical service network can take place via a cigarette lighter socket and/or a fuse plug.

According to another possible feature, the method comprises a step of providing an electrical access point, inside the vehicle, to the service battery in order to establish an electrical connection between a third-party device, such as a recharging or diagnostics device and said service battery.

According to another possible feature, the fuse connecting the cigarette lighter socket to the battery is positioned in a so-called “continuous power supply” position, i.e. in a position in which said cigarette lighter socket is electrically connected to the battery (i.e. powered), even when the vehicle is switched off.

The invention will be better understood, and other aims, details, features and advantages thereof will appear more clearly throughout the following description of particular embodiments of the invention, given only for illustrative and non-limiting purposes, with reference to the accompanying drawings, wherein:

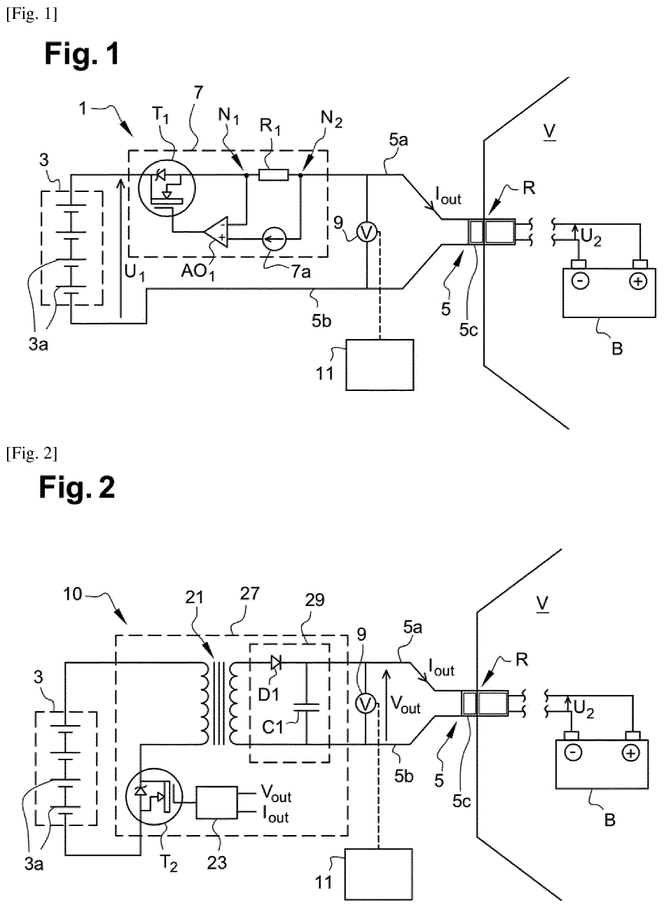

FIG. 1 is a very diagrammatic view of a first embodiment of a battery charger according to the invention;

FIG. 2 is a very diagrammatic view of a second embodiment of a battery charger according to the invention;

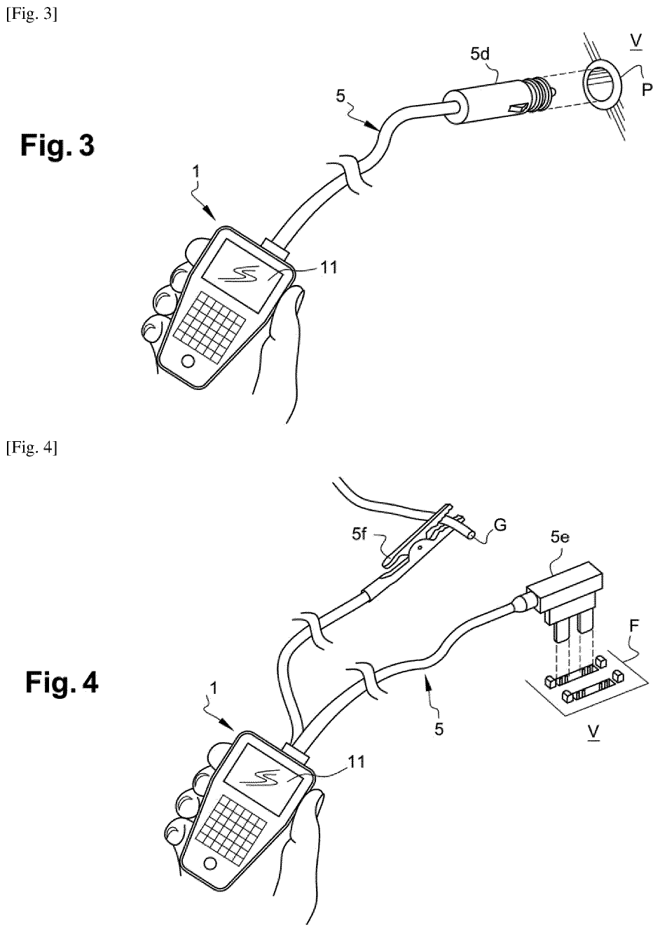

FIG. 3 is a diagrammatic, perspective view of the charger in FIG. 1 connected to the electrical service network of a vehicle via a cigarette lighter socket, and

FIG. 4 is a diagrammatic, perspective view of the charger in FIG. 1 connected to the electrical service network of a vehicle via a fuse plug.

FIG. 1 is a very diagrammatic view of a first embodiment of a battery charger 1 for an electric vehicle V.

The battery charger 1 thus comprises:
an electrical power source 3;
an electrical connection 5 which is configured to be connected to the electrical service network R of the vehicle V and which comprises two electrical cables 5a and 5b and a connector 5c;
an electrical (and/or electrotechnical) management circuit 7 configured to limit the intensity of the output electrical current I_{OUT} (or charging current) flowing, via said electrical connection 5, from the electrical power source 3 to an electrical battery B of the vehicle V;
a voltmeter 9 configured to measure the voltage (or an image of the voltage) of the battery B to be charged;
a human-machine interface 11 which is configured to indicate one or more pieces of information to the user of said charger 1, and which is in particular connected to said voltmeter 9.

It should also be noted that said charger 1 optionally comprises an electronic circuit (not shown) for managing the various elements mentioned hereinabove.

It should be noted that said management circuit 7 can be integrated into the cable 5a of the connection 5 connecting the positive terminal of the power source 3 to the positive terminal of the battery B of the vehicle or can be a separate element interposed between said cable 5a and the power source 3. The cable 5b connects the negative terminal of the power source 3 to the negative terminal of the battery B of the vehicle.

In the present embodiment, said power source 3 is an electric battery comprising four lithium-ion type cells 3a, disposed in series, each having a voltage of about 4 V. The dimensions of the pack of 4 cells 3a are approximately 84×70×21 mm.

The electric battery 3 of the charger 1 thus has a rated voltage U₁ of about 16 volts, whereas a service battery of an electric vehicle has a usual rated voltage U₂ of about 12 V. Thus, the battery 3 has a rated voltage U₁ that is higher than the rated operating voltage U₂ of the battery B of the electric vehicle V to be charged.

Said charger further comprises a USB socket (not shown) configured to supply electricity to said electrical power source 3. In the present embodiment, said USB socket is thus used to recharge the battery 3 of the charger 1.

Said electrical management circuit 7 is configured to limit the intensity of the output (or charging) current I_{OUT}, which flows from the battery 3 of the charger 1 to the battery B of the vehicle V, to a predetermined maximum value Iₘₐₓ. Advantageously, the predetermined maximum value Iₘₐₓ is 10 amps, and preferably 8 amps.

For this purpose, said electrical management circuit 7 includes a current-limiting circuit which comprises:
a transistor T₁, such as a MOSFET or bipolar transistor, whose drain (or collector) is connected to the positive terminal of the battery 3 of the charger;
a resistor R₁ connected to the source (or emitter) of the transistor T₁;
a reference voltage source 7a outputting a voltage V_{REF};
an operational amplifier AO₁ whose output is connected to the gate (or base) of the transistor T₁, whose inverting input is connected to a node N₁ located between the source of the transistor T₁ and the resistor R₁, and whose non-inverting input is connected to the output of the reference voltage source 7a.

It should be noted that the input of the reference voltage source 7a is connected to a node N₂ which is in turn connected to one of the terminals of the resistor R₁, each of the terminals of said resistor R₁ being connected to the nodes N₁ and N₂ respectively.

Thus, the elements listed hereinabove allow for linear regulation of the output (or charging) current I_{OUT}. More specifically, the operational amplifier AO₁ amplifies the difference between the voltages received at the inputs (inverting and non-inverting inputs) thereof and outputs a voltage which thus regulates the amount of current flowing through the transistor T₁ (and thus generally speaking the amount of current flowing from the battery 3 of the charger 1 to the battery B of the vehicle).

By carefully choosing the values of the resistor R₁ and of the reference voltage V_{REF}, a circuit 7 is obtained which limits the intensity of the current to a predetermined value Iₘₐₓ. For example, for R₁=0.1Ω and V_{REF}=0.8 V, this gives Iₘₐₓ=8 A.

The human-machine interface 11 comprises one or more light indicators, such as light-emitting diodes (or LEDs), that turn on or off to indicate the status of the charger and/or the status of the battery of the vehicle to the user. It could also indicate a state of charge, for example by a colour code for the light-emitting diodes.

The human-machine interface 11 can thus indicate whether:
the charger is switched on and ready for use;
said charger is currently charging the battery of the vehicle, in particular the service battery;
the voltage value of the battery to be charged has reached or exceeds a predetermined voltage value, for example the theoretical rated operating voltage of said battery to be charged.

In an alternative embodiment not shown, the human-machine interface includes a display indicating the aforementioned statuses.

Said display can also indicate:
the charge and/or voltage value of the battery of the vehicle and/or of the electrical power supply.
that the electrical power source of said charger is charged up or exceeds a predetermined voltage value.

Thus, the user can proceed, using said charger 1, to repair an electric (or hydrogen electric) vehicle, whose function battery B needs to be recharged.

The user, after mechanically unlocking one of the doors of the vehicle, connects the charger 1, using the electrical connection 5, to the electrical service network R of the vehicle V.
The connection to the electrical service network R of the vehicle V can be made in various ways, for example via the cigarette lighter socket P, as shown in [FIG. 3], or via a fuse plug F, as shown in [FIG. 4].

More particularly, in FIG. 3, said electrical connection 5 thus comprises a connector 5d configured to cooperate with the cigarette lighter socket P. In the embodiment shown in FIG. 4, said electrical connection 5 comprises a connector 5e configured to cooperate with the fuse plug F (in particular located in the fuse box of the vehicle V) and a ground connector 5f configured to be fixed to an element G, in particular an element of the vehicle V, acting as an electrical ground.

It should be noted that it is sometimes necessary for the fuse of the cigarette lighter socket to be in a so-called “continuous power” position to allow the charger according to the invention to operate when the vehicle is switched off.

After the charger has been used, the fuse can be returned to a so-called “cut-off” position or advantageously left in the continuous power position.

It should also be noted that, in the case of an electrical connection via a fuse plug, a part of the electrical network that is suitable for the currents to be injected must be selected and the fuse present must be removed beforehand.

The charger 1 thus indicates, via the human-machine interface 11 (such as an indicator light), that the charger 1 is currently charging the function battery B of the vehicle.

Once the battery B of the vehicle reaches a predetermined voltage value, such as the rated operating voltage U₂ thereof, the human-machine interface indicates to the user that the function battery B is charged and that the user can start up the electric vehicle V.
It should be noted that, beforehand, said human-machine interface 11 can also indicate, for example by an indicator light, that the charger 1 is operational and capable of charging said battery B of the vehicle.

In an alternative embodiment not shown, the charger automatically switches off as soon as the voltage of the battery to be charged exceeds a threshold value.

FIG. 2 is a very diagrammatic view of a second embodiment of a charger 10 according to the invention. The same elements bear the same reference numerals as those used in the first embodiment and will thus not be described again.

Thus, unlike for the first embodiment, said electrical management circuit 27 is configured, on the one hand, to limit the intensity of the current I_{OUT} at the output of the charger 10, and, on the other hand, to raise and/or lower the output voltage V_{OUT} of said charger 10.

More particularly, said electrical management circuit 27 is advantageously configured to raise and/or lower the voltage of the electrical power source such that the output voltage V_{OUT} of said electrical management circuit 27 is always adapted with respect to the rated voltage value of the battery B to be charged. It should be noted that the electrical management circuit 27 typically raises the voltage received by the battery from the charger 3 so that the output voltage V_{OUT} is higher than the rated voltage U₂ of the battery B to be charged.

More particularly, said electrical management circuit 27 comprises:
a transformer 21 connected to the terminals of the battery 3 of the charger 10, via a transistor T₂;
a control circuit 23 connected to the transistor T₂, more particularly at the gate of the transistor T₂, configured to limit the intensity of the output current I_{OUT} and to regulate the value of the output voltage V_{OUT};
a rectifying and filtering circuit 29, which itself comprises a diode D₁ and a capacitor C₁, configured so that the output voltage V_{OUT} is a DC voltage.

More particularly, the source of the transistor T₂ is connected to the negative terminal of the battery 3 of the charger 10, whereas the drain of the transistor T₂ is connected to the transformer 21.

Said transistor T₂ is controlled by the control circuit 23, which in turn is slaved to the output voltage V_{OUT} and the output current I_{OUT}. Said control circuit 23 also has setpoint values for the output voltage V_{OUT} and output current I_{OUT}, for example 16 V and 8 A.

Thus, said control circuit 23, depending on the values of the output voltage V_{OUT} and output current I_{OUT} and the setpoint voltage and current values, regulates the gate voltage of the transistor T₂, which causes the source-drain current to be modulated until the output voltage and current correspond to the values of the setpoint voltages and current.

The present invention further relates to an electric or hydrogen electric motor vehicle, comprising a battery charger as described hereinabove, said charger being an on-board system of said vehicle.

When the charger is integrated into a motor vehicle, it is advantageously, on the one hand, configured to perform diagnostics on said service battery and, on the other hand, integrated into the vehicle, said power source of the charger thus advantageously being the traction battery of said vehicle. Said charger can further comprise another electrical power source, such as a battery, etc. Said integrated charger is thus configured to switch on, automatically or manually, to maintain a predetermined charge of said service battery, in order to avoid the service battery from being discharged to the extent of no longer allowing said vehicle to start.

1. Charger (1; 10) for a service battery of an electric vehicle, said charger comprising:
an electrical power source (3);
an electrical connection (5) configured to be connected to the electrical service network of the vehicle and connect said electrical power source (3) to the service battery of the vehicle;
an electrical management circuit (7; 27) configured to limit the intensity of the electrical current (I_{OUT}) flowing, via the electrical service network, from the electrical power source (3) to the service battery of the vehicle.

2. Charger according to the preceding claim, characterised in that said electrical connection (5) is configured to connect to a cigarette lighter socket and/or a fuse plug.

3. Charger according to claim 1 or 2, characterised in that the electrical power source (3) is a battery with a rated voltage (U₁) that is higher than the rated operating voltage (U₂) of the service battery to be charged.

4. Charger according to the preceding claim, characterised in that said battery (3) is an electric battery of the lithium-ion type having a rated voltage (U₁) of at least 14 V, and preferably a rated voltage of at least 16 V.

5. Charger according to the preceding claim, characterised in that said electrical management circuit (7; 27) limits the charging current intensity (I_{OUT}) to a predetermined value, such as to 10 amps, and preferably to 8 amps.

6. Charger according to any one of the preceding claims, characterised in that said electrical management circuit (7; 27) is configured to raise the voltage and/or lower the voltage of the electrical power source (3).

7. Charger according to any one of the preceding claims, characterised in that it comprises a human-machine interface (11) configured to indicate one or more of the following pieces of information to the user:
said charger is switched on;
said charger is currently charging the service battery of the vehicle;
the voltage value of the service battery to be charged has reached or exceeds a predetermined voltage value;
the voltage value of the service battery to be charged and/or of the electrical power source;
the electrical power source of said charger is charged up and/or exceeds a predetermined voltage value;
the charge and/or the voltage value of the electrical power source of said charger.

8. Charger according to any one of the preceding claims, characterised in that said charger (1) automatically switches off as soon as the voltage of the service battery to be charged exceeds a threshold value.

9. Charger according to any one of the preceding claims, characterised in that said charger (1) comprises a USB socket configured to supply electricity to said electrical power source (3).

10. Charger according to any one of the preceding claims, characterised in that it is, on the one hand, configured to perform diagnostics on said service battery and is, on the other hand, integrated into the vehicle, said power source of the charger being the traction battery of said vehicle.

11. Method for repairing a service battery of an electric or hydrogen electric vehicle using a charger for a service battery according to any one of claims 1 to 10, said method including the following steps of:
connecting an electrical power source to the electrical service network of the vehicle;
supplying the service battery of the vehicle via the electrical network with a current, the intensity whereof is limited to a predetermined value.

12. Method according to the preceding claim, characterised in that the user is warned when the voltage value of the service battery has reached a predetermined voltage value.

13. Method according to the preceding claim, characterised in that a connection is made to the electrical service network via a cigarette lighter socket and/or a fuse plug.

14. Method according to claim 12, characterised in that it comprises a step of providing an electrical access point, inside the vehicle, to the service battery in order to establish an electrical connection with a third-party device, such as a recharging and diagnostics device for said service battery.
